(19) United States
(12) Patent Application Publication
(10) Pub. No.: US 2002/0054800 A1
(43) Pub. Date: May 9, 2002

(54) PCB separator having monitoring system for route finding and adjusting purposes

(76) Inventors: Tzong Her Hwu, Chong Ho City (JP); Kun Chuan Wang, Chong Ho City (TW)

Correspondence Address: Yong Chang Chang, P.O. Box 10-69, Chong-Ho, Taipei, TW

(21) Appl. No.: 10/045,074

(22) Filed: Jan. 15, 2002

Related U.S. Application Data
(63) Continuation-in-part of application No. 09/469,779, filed on Dec. 22, 1999.
Application No. 09/469,779 is a continuation-in-part of application No. 09/507,054, filed on Jan. 19, 2000.

(51) Int. Cl. B23C 1/00

(52) U.S. Cl. 409/116; 409/134; 408/16

(57) ABSTRACT

A PCB separator includes a machining device for machining work pieces, and a charge couple device attached to the machining device and the tool member for taking pictures of the work piece. A monitor is coupled to the charge couple device for showing the pictures of the work piece. An index generator is coupled to the monitor for generating and sending a cross-shaped index to the monitor, and includes an adjusting knob for adjusting the sizes of the index relative to the work piece, for allowing the work piece to be precisely machined.

The present application is a continuation-in-part of U.S. patent application Ser. No. 09/469,779, filed on Dec. 22, 1999, and is also a continuation-in-part of U.S. patent application Ser. No. 09/507,054, filed on Jan. 19, 2000, both to be abandoned.

### BACKGROUND OF THE INVENTION

1. Field of the Invention

The present invention relates to a printed circuit board (abbreviated as PCB hereinafter) separator, and more particularly to a PCB separator having a monitoring system for route finding and adjusting purposes.

2. Description of the Prior Art

Various kinds of typical working machines have been developed for cutting objects. For example, U.S. Pat. No. 4,891,767 to Rzasa et al., U.S. Pat. No. 4,918,611 to Shyu et al., U.S. Pat. No. 4,988,200 to Cohen-Sabban, U.S. Pat. No. 4,999,895 to Hirose et al., U.S. Pat. No. 5,165,829 to Ross et al., U.S. Pat. No. 5,339,103 to Schmidt et al., and U.S. Pat. No. 6,059,494 to Susnjara, disclose several of the working machines. Some of the working machines may include a camera, or a charge couple device for routing finding and tracking purposes, and may include a displayer for displaying the cutting tracks or routes to the work pieces. However, the working machines are good for working large particles or work pieces, and may not be used for cutting fine work pieces, such as the printed circuit boards.

The other typical working machines, such as U.S. Pat. No. 4,829,375 to Alzmann et al., and U.S. Pat. No. 5,529,441 to Kosmowski et al. disclose two of the typical working machines which may be used for cutting or working with the fine work pieces, such as the printed circuit boards. The typical working machines may comprise a camera, or a charge couple device for routing finding and tracking purposes, and may include a displayer for displaying the cutting tracks or routes to the work pieces. However, the camera or the charge couple device may not be zoomed toward the printed circuit boards, or the images of the work pieces in the displayers may not be enlarged, or the index may be changed for enlarging the work pieces and for allowing the work piece to be precisely cut or machined.

Japanese Patent Document 1-120664 to Sakaguchi discloses a character input device and includes an adjusting knob for changing a designated value and for adjusting or changing the display size of a cursor. However, only the display size of the cursor may be changed. The images in the displayers may not be changed, and may not be controlled with a remote control device or the like.

The present invention has arisen to mitigate and/or obviate the afore-described disadvantages of the conventional PCB separators.

### SUMMARY OF THE INVENTION

The primary objective of the present invention is to provide a PCB separator including a monitoring system for viewing the cutting process on the work pieces and for preventing the workers from entering into the cutting or working area of the machining device.

The other objective of the present invention is to provide a PCB separator including a monitoring system for detecting and finding and for precisely determining the cutting route on the work pieces in order to increase the precision and accuracy on the dimensions of the end products and in order to machine the PCB automatically.

In accordance with one aspect of the invention, there is provided a PCB separator for machining work pieces, the PCB separator comprising a base, a machining device disposed on the base for machining a work piece, the machining tool including at least one X-axis sliding guide, at least one Y-axis sliding guide, at least one Z-axis sliding guide, a support, a tool member attached to the support for machining the work piece, means for moving the support and the tool member relative to the base along the X-axis sliding guide and the Y-axis sliding guide and the Z-axis sliding guide, means for photographing and taking pictures of the work piece, the photographing means including a charge couple device attached to the support and moved in concert with the support and the tool member for taking the pictures of the work piece, a monitor coupled to the photographing means and to receive and show the pictures of the work piece on the monitor, means for actuating the machining device, the actuating means including a remote control, and including a central processing unit coupled to the machining device for actuating the machining device and coupled to the charge couple device with an image grabbing card, and means for generating a cross-shaped index on the monitor, the index generating means including an index generator coupled to the monitor for sending and showing the cross-shaped index in the monitor, the cross-shaped index including a center coincident with the tool member, and the index generator including an adjusting knob for adjusting the cross-shaped index relative to the work piece or for enlarging the image of the work piece, and for allowing the work piece to be precisely machined.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a PCB separator with a monitoring system in accordance with the present invention;

FIG. 2 is an exploded view illustrating the base of the PCB separator;

FIG. 3 is a perspective view illustrating the machining device disposed on top of the base;

FIG. 4 is a partial plane schematic view showing the vertical sliding guide of the machining device;

FIG. 5 is an exploded view illustrating the members of the monitoring system to be attached to the PCB separator;

FIG. 6 is a plane view of the screen of the monitor;

FIG. 7 is a block diagram of the monitoring system for the PCB separator; and

FIG. 8 is another block diagram illustrating the monitoring system for the PCB separator.

### DETAILED DESCRIPTION OF THE PREFERRED EMBODIMENT

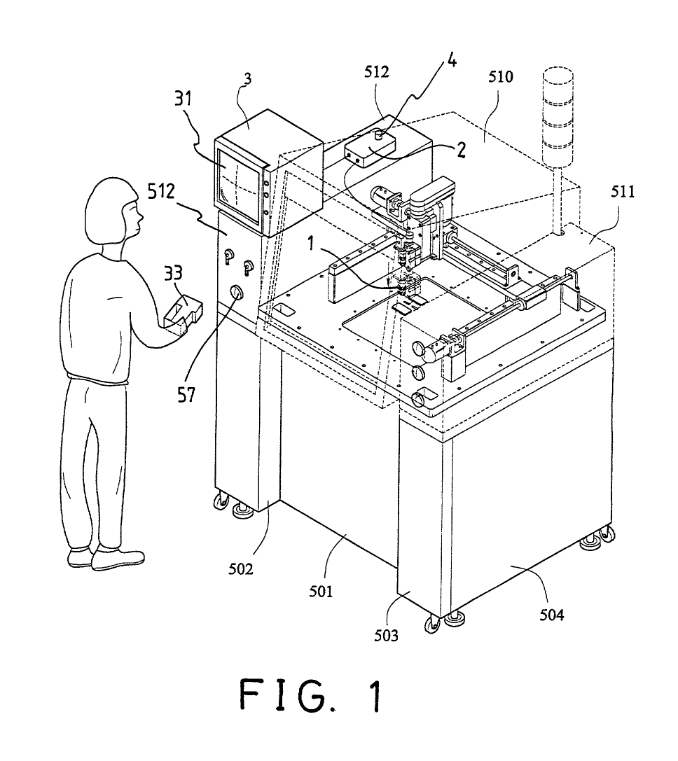

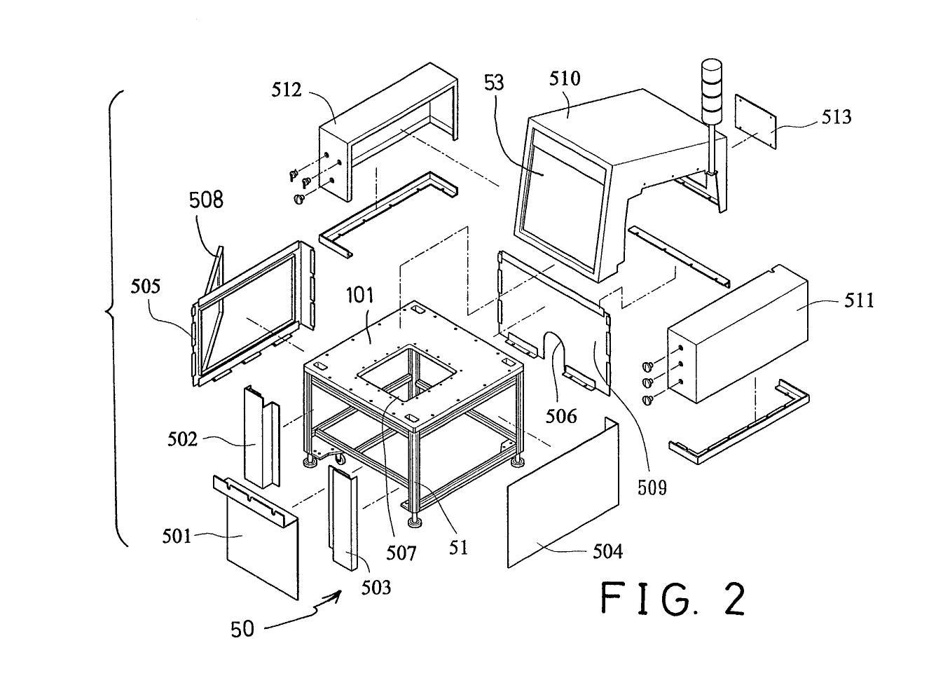

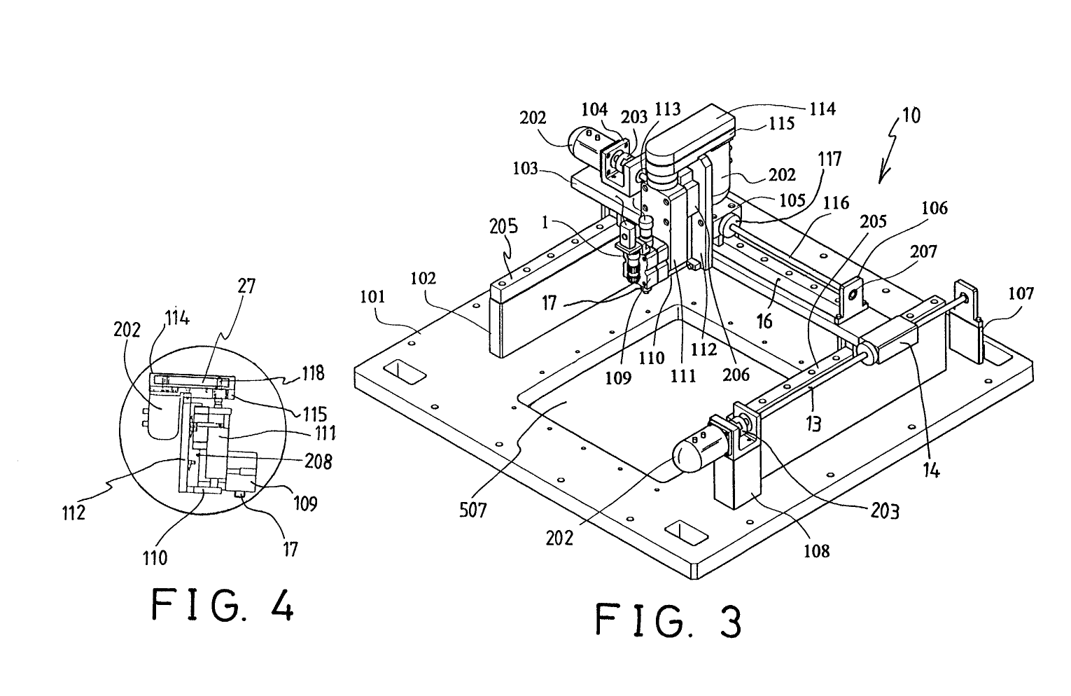

Referring to the drawings, and initially to FIGS. 1-4, a working machine in accordance with the present invention, particularly a PCB separator, comprises a base 50 including a frame 51, a front panel 501 and two front side panels 502, 503 attached to the front portion of the frame 51, two side panels 504, 505 attached to the side portions of the frame 51, and a rear panel 509 attached to the rear portion of the frame 51. A door 508 is pivotally secured to the side panel 505 and can be used for entering into the inner portion of the frame 51 whilst the door 508 is opened. The frame 51 includes a board 101 disposed on top for supporting the machining device 10, as shown in FIG. 3, which will be discussed hereinafter. The board 101 includes an orifice 507 formed therein for receiving and collecting the dust or the chips cut by the machining device 10. A chute or a tube may be provided and coupled to the orifice 507 and may be coupled to a vacuum device for vacuuming and collecting the dust or the chips cut by the machining device 10. The tube may extend outward of the frame 51 via a hole 506 of the rear panel 509. A housing 510 is disposed on top of the board 101 for shielding or covering the machining device 10, and includes a detachable rear plate 513 for entering into the housing 510 when the rear plate 513 is disengaged from the housing 510. The housing 510 includes a front opening 53 formed therein for allowing the upper portions and the hands of the workers to enter into the housing 510 when required. Two casings 511, 512 are disposed on the side portions of the board 101 and are provided for shielding or covering the machining device 10.

As shown in FIGS. 1 and 3-4, the machining device 10 includes a pair of X-axis sliding guides 205 disposed on top of a respective seat 102 which is disposed on or extended upward from the board 101. A threaded rod or a bolt 13 is rotatably supported on the board 101 with a pair of seats 107, 108 and parallel to the X-axis sliding guides 205. A table 103 is slidably engaged on the X-axis sliding guides 205 and movable along the sliding guides 205, and includes a threaded member or a nut 14 secured to the side portion thereof and threaded with the bolt 13. A motor 202, such as a step or servo motor, is disposed on the seat 108 and coupled to the bolt 13 with a coupler 203 for rotating the bolt 13 and thus for driving and moving the table 103 along the sliding guides 205.

A Y-axis sliding guide 16 is disposed on the table 103, and a threaded rod or a bolt 116 is rotatably supported on the table 103 with a pair of seats 104, 106 by bearings 113, 207 and parallel to the Y-axis sliding guide 16 and perpendicular to the X-axis sliding guides 205. A holder 112 is secured on a block 105 which is slidably engaged on the Y-axis sliding guide 16 and movable along the sliding guide 16. The block 105 includes a threaded member or a nut 117 provided therein and threaded with the bolt 116. A motor 202, such as a step motor or a servo motor, is disposed on the seat 104 and coupled to the bolt 116 with a coupler 203 for rotating the bolt 116 and thus for driving and moving the block 105 and thus the holder 112 along the sliding guide 16.

A Z-axis sliding guide 208 (FIG. 4) is vertically disposed or secured on the holder 112, and a threaded rod or a bolt 118 is rotatably secured to and supported on the holder 112 with a pair of seats 110, 115 by bearings and parallel to the Z-axis sliding guide 208 and vertical or perpendicular to the Y-axis sliding guide 16 and the X-axis sliding guides 205. A bracket 111 is slidably engaged on the Z-axis sliding guide 208 and movable along the sliding guide 208 and is threaded with the bolt 118. A motor 202, such as a step motor or a servo motor, is attached to the seat 115 and coupled to the bolt 118 with a belt transmission 27 for rotating the bolt 118 and thus for driving and moving the bracket 111 along the Z-axis sliding guide 208. A cover 114 is secured on top of the seat 115 for enclosing and for shielding the belt transmission 27. A support 109 is attached to the bracket 111 for supporting a tool member 17, such as a cutting or milling or drilling tool. A number of buttons and/or knobs 57 are attached to the casings 511, 512 for controlling the machining device 10. The above-described machining device 10 is conventional.

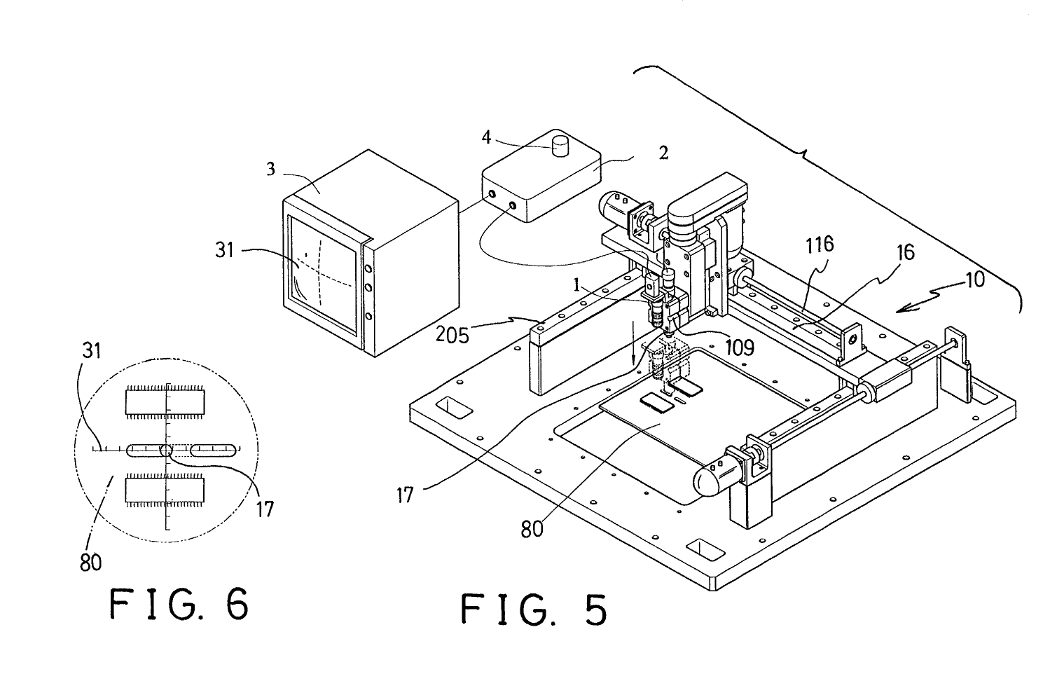

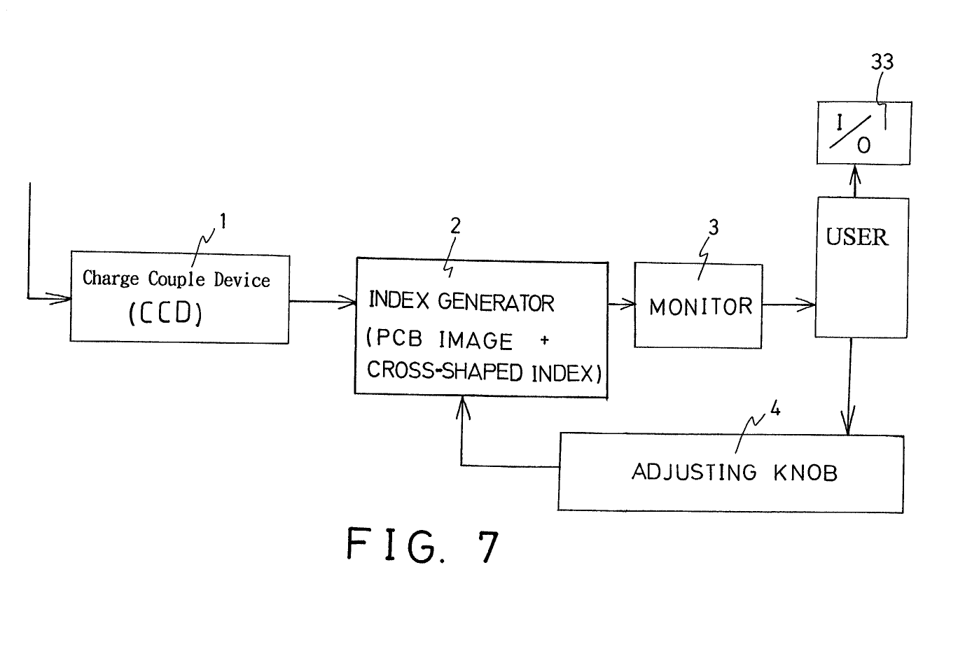

Referring next to FIGS. 5-7 and again to FIG. 1, the PCB separator in accordance with the present invention further includes a processor device having a monitor 3 disposed on the casing 512. An index generator 2 is also preferably disposed on the casing 512 and coupled to the monitor 3 for generating an index, such as a cross-shaped index 31 in the monitor 3. The index generator 2 includes an adjusting knob 4 which may be used for adjusting the sizes of the index 31 according to the sizes of the cutting tools. A charge couple device (abbreviated as CCD hereinafter) 1 attached to the support 109 and moved in concert with the support 109 and the tool member 17, for taking the picture or the image of the PCB 80 or for photographing the PCB 80. The for sending the picture of the PCB 80 to the monitor 3. The index 31 generated by the index generator 2 may also be sent to the monitor 3. The user may thus view the screen of the monitor 3 and may use an input/output device and/or a wire or remote control device 33 to control or to operate the machining device 10, without entering his upper portion into the front opening 53 of the housing 510. The central point of the cross-shaped index 31 is preferably coincided with the tool member 17 (FIG. 6). The work piece(s) (the PCB 80) to be cut by the machining device 10 may be disposed on the board 101 and disposed below the tool member 17 so as to be machined by the tool member 17.

In operation, in the beginning, the workers or the users may use the input/output device and/or the wire or remote control device 33 to control or to operate the machining device 10 and to determine the working or cutting route onto the PCB 80. The working or cutting route may then be memorized in the processor device such that the tool member 17 of the machining device 10 may be actuated to move along the memorized working or cutting route in order to machine or cut the other PCBs 80. The PCBs 80 may thus be precisely cut by the machining device 10 automatically. In addition, the workers need not enter into the housing 510 and thus will not be hurt by the cutting chips or dirt.

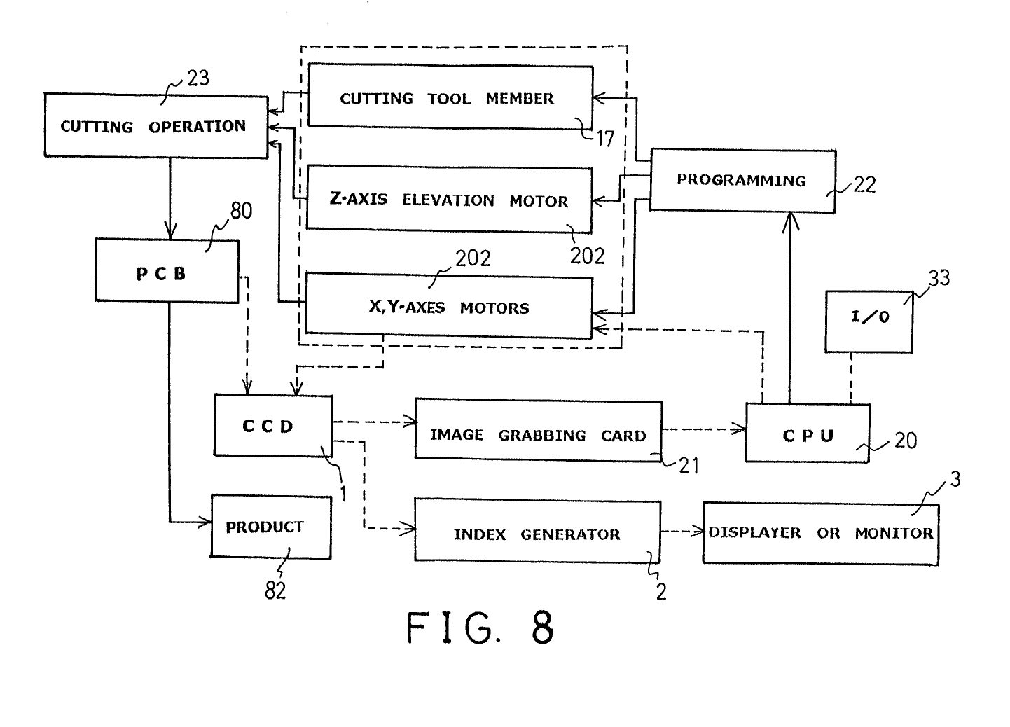

For more details, or for example, the processor device includes a central processor unit (CPU) 20 (FIG. 8), the displayer or the monitor 3 disposed on the casing 512, and the index generator 2 preferably disposed on the casing 512 and coupled to the monitor 3 for generating the index, such as the cross-shaped index 31 in the monitor 3. The charge couple device 1 is attached to the support 109 and moved in concert with the support 109 and the tool member 17, for taking the picture or the image of the PCB 80 or for photographing the PCB 80. The CCD 1 is coupled to the index generator 2 and is coupled to the CPU 20 via an image grabbing card 21 for sending the picture of the PCB 80 to the CPU 20 and to the monitor 3. The index 31 generated by the index generator 2 may also be sent to the monitor 3. The user may thus view the screen of the monitor 3 and may use an input/output (I/O) device (keyboard) and/or a wire or remote control device 33 to control or to operate the machining device 10, without entering his upper portion into the front opening 53 of the housing 510. The central point of the cross-shaped index 31 is preferably coincided with the tool member 17 (FIG. 6). The work piece(s) (the PCB 80) to be cut by the machining device 10 may be disposed on the board 101 and disposed below the tool member 17 so as to be machined by the tool member 17.

The workers or the users may use the input/output device (keyboard) and/or the wire or remote control device 33 to actuate the CPU (20) in order to control or to operate the machining device 10 and to determine the working or cutting route onto the PCB 80. For example, as shown in FIG. 8, when the CPU 20 is actuated by entering a control message, such as the size of the PCB 80 to be cut or to be obtained, into the CPU 20 with the I/O 33, the X-axis and the Y-axis driving motors 202 may be directly actuated by the CPU 20 or by the programming 22 of the CPU 20 to move the CCD 1 in either or both the lateral direction and the forward and rearward direction, preferably step by step, in order to detect and/or to find and/or to determine the cutting route to be done onto the work pieces 80. The thus determined working or cutting route may then be memorized in the central processor unit 20 which may then actuate the tool member 17 of the machining device 10, with the programming 22 of the CPU 20, to move along the memorized working or cutting route with the X-axis, Y-axis and/or Z-axis driving motors 202 in order to conduct the machining or the cutting operation 23 onto the other PCBs 80 automatically. The PCBs 80 may thus be precisely cut into the products 82 having the required sizes and shapes by the machining device 10 automatically. In addition, the workers need not enter into the housing 510 and thus will not be hurt by the cutting chips or dirt.

When the PCB 80 to be cut is deformed, the CCD 1 may take and send the picture to the CPU 20 which may calculate, with the programming 22 thereof, the difference between the deformed shape of the deformed PCB and the memorized shape of the undeformed PCB, in order to determine the machining or cutting route to be done onto the deformed PCB 80, and in order to precisely cut the deformed PCB 80.

The camera or the charge couple device may be zoomed toward the printed circuit boards. The adjusting knob 4 of the index generator 2 may be used for adjusting the sizes of the cross-shaped index 31 relative to the work pieces, or the images of the work pieces in the monitor 3 may be enlarged relative to the cross-shaped index 31, or the cross-shaped index 31 may be changed or enlarged relative to the work pieces, for allowing the printed circuit boards to be clearly seen, and for allowing the work piece to be precisely cut or machined by the tool member 17.

Accordingly, the PCB separator in accordance with the present invention includes a monitoring system for viewing the cutting process on the work pieces and for precisely determining the cutting route on the work pieces in order to increase the precision and accuracy on the dimensions of the end products. The workers may be prevented from entering into the cutting or working area of the machining device such that the safety for the workers is greatly increased.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A PCB separator for machining work pieces, said PCB separator comprising:
a base,
a machining device disposed on said base for machining a work piece, said machining tool including at least one X-axis sliding guide, at least one Y-axis sliding guide, at least one Z-axis sliding guide, a support, a tool member attached to said support for machining the work piece,
means for moving said support and said tool member relative to said base along said at least one X-axis sliding guide and said at least one Y-axis sliding guide and said at least one Z-axis sliding guide,
means for photographing and taking pictures of the work piece, said photographing means including a charge couple device attached to said support and moved in concert with said support and said tool member for taking the pictures of the work piece,
a monitor coupled to said photographing means and to receive and show the pictures of the work piece on said monitor,
means for actuating said machining device, said actuating means including a remote control, and including a central processing unit coupled to said machining device for actuating said machining device and coupled to said charge couple device with an image grabbing card, and
means for generating a cross-shaped index on said monitor, said index generating means including an index generator coupled to said monitor for sending and showing the cross-shaped index in said monitor, said cross-shaped index including a center coincident with said tool member, and said index generator including an adjusting knob for adjusting said cross-shaped index relative to the work piece and for allowing the work piece to be precisely machined.
